(19) United States
(12) Patent Application Publication
(10) Pub. No.: US 2025/0189953 A1
(43) Pub. Date: Jun. 12, 2025

(54) INFORMATION PROCESSING METHOD AND INFORMATION PROCESSING DEVICE

(71) Applicant: Panasonic Intellectual Property Management Co., Ltd., Osaka (JP)

(72) Inventors: Hironori OHIGASHI, Osaka (JP); Akira MINEGISHI, Osaka (JP)

(21) Appl. No.: 18/842,281

(22) PCT Filed: Feb. 14, 2023
(86) PCT No.: PCT/JP2023/005054

§ 371 Date: Aug. 28, 2024

(30) Foreign Application Priority Data
Mar. 28, 2022 (JP) 2022-051334

(51) Int. Cl. G05B 19/418

(52) U.S. Cl. CPC G05B 19/4184

(57) ABSTRACT

An information processing method includes: associating information related to an anomaly that has occurred in equipment with a maintenance effect when maintenance of the equipment is performed for the anomaly; and outputting, based on the maintenance effect, information identifying recommended maintenance to be performed for the anomaly in the equipment.

### TECHNICAL FIELD

The present disclosure relates to an information processing method and an information processing device.

### BACKGROUND ART

Patent Literature (PTL) 1 discloses a production line management device that determines the priority order of treatment for an anomaly in equipment based on a processed part, an equipment configuration, anomaly details, and the like.

### CITATION LIST

### Patent Literature

[PTL 1] Japanese Patent No. 3669403

### SUMMARY OF INVENTION

### Technical Problem

However, the conventional production line management device may not be able to sufficiently improve productivity.

Accordingly, the present disclosure provides an information processing method and an information processing device capable of effectively supporting productivity improvement.

### Solution to Problem

An information processing method according to one aspect of the present disclosure includes: associating information related to an anomaly that has occurred in equipment with a maintenance effect when maintenance of the equipment is performed for the anomaly; and outputting, based on the maintenance effect, information identifying recommended maintenance to be performed for the anomaly in the equipment.

An information processing device according to one aspect of the present disclosure includes: an associator that associates information related to an anomaly that has occurred in equipment with a maintenance effect when maintenance of the equipment is performed for the anomaly; and an output unit that outputs, based on the maintenance effect, information identifying recommended maintenance to be performed for the anomaly in the equipment.

Further, one aspect of the present disclosure can be implemented as a program for causing a computer to execute the information processing method. Alternatively, one aspect of the present disclosure can be implemented as a non-transitory computer-readable recording medium storing the program.

### Advantageous Effects of Invention

According to the present disclosure, it is possible to effectively support productivity improvement.

### BRIEF DESCRIPTION OF DRAWINGS

FIG. 1 is a diagram illustrating a configuration of an information processing system according to an embodiment.

FIG. 2 is a block diagram illustrating a configuration of an information processing device according to the embodiment.

FIG. 3 is a diagram illustrating an example of detected anomaly data.

FIG. 4 is a diagram illustrating an example of maintenance information that is output.

FIG. 5 is a diagram illustrating an example of maintenance result data.

FIG. 6 is a diagram illustrating an example of maintenance effect data.

FIG. 7 is a flowchart illustrating an accumulation process for maintenance effect data in the operation of the information processing device according to the embodiment.

FIG. 8 is a flowchart illustrating an output process for maintenance information in the operation of the information processing device according to the embodiment.

### DESCRIPTION OF EMBODIMENTS

### Overview of the Present Disclosure

An information processing method according to one aspect of the present disclosure includes: associating information related to an anomaly that has occurred in equipment with a maintenance effect when maintenance of the equipment is performed for the anomaly; and outputting, based on the maintenance effect, information identifying recommended maintenance to be performed for the anomaly in the equipment.

Thus, the maintenance effect is used, enabling the output of information identifying recommended maintenance with a high effect on productivity improvement. Therefore, according to the information processing method in the present aspect, it is possible to support productivity improvement.

For example, the information processing method according to one aspect of the present disclosure may further include obtaining operation statuses of the equipment before and after the maintenance is performed.

An anomaly that has occurred once is likely to occur again, and maintenance performed for the anomaly is likely to be performed again. According to the present aspect, since the operation statuses of the equipment before and after the maintenance is actually performed are obtained, it is possible to output information identifying recommended maintenance effective for improving productivity. This eliminates the need for an exhaustive investigation into combinations of equipment and anomalies, enabling the output of information identifying effective recommended maintenance with low throughput.

For example, in the associating, an improvement rate for the equipment resulting from the maintenance may be calculated as the maintenance effect based on the operation statuses of the equipment before and after the maintenance is performed.

Thus, the improvement rate resulting from the maintenance is calculated, enabling the output of information identifying recommended maintenance that is directly linked to productivity improvement.

For example, in the associating, a first cumulative value of stoppage times due to the anomaly during a first period before the maintenance is performed and a second cumulative value of stoppage times due to the anomaly during a second period of the same length as the first period after the maintenance is performed may be calculated, and a ratio of a difference value, obtained by subtracting the second cumulative value from the first cumulative value, to the first cumulative value may be calculated as the improvement rate.

This makes it possible to accurately calculate the improvement rate resulting from maintenance.

For example, in the associating, the maintenance effect may be associated with each of a plurality of anomalies that have occurred in the equipment. The information processing method may further include setting, based on the maintenance effect, a priority on information identifying recommended maintenance for the corresponding anomaly for each of the plurality of anomalies. In the outputting, the information identifying the recommended maintenance may be associated with the priority and be output.

Thus, the priority is associated with the recommended maintenance, enabling the determination of the work order of maintenance based on the priority. By reducing the room for human determination in setting the priority, the dependency on a human for determining the work order of maintenance can be reduced. When a plurality of anomalies occur in a plurality of pieces of equipment, an operator can be notified of the work order of maintenance for the anomalies, thereby effectively improving productivity.

For example, the information processing method according to one aspect of the present disclosure may further include calculating an anomaly level of each of the plurality of anomalies that has occurred in the equipment. In the setting, the priority may be set based on the maintenance effect and the anomaly level. For example, in the setting, the product of the maintenance effect and the anomaly level may be set as the priority.

Thus, the anomaly level is used for setting the priority, making it possible, for example, to set a high priority on urgent maintenance for an anomaly that occurs frequently. In this manner, it is possible to set a priority according to the actual situation.

A program according to one aspect of the present disclosure is a program for causing a computer to execute the information processing method according to the above aspect.

As a result, it is possible to support productivity improvement similarly to the above information processing method.

An information processing device according to one aspect of the present disclosure includes: an associator that associates information related to an anomaly that has occurred in equipment with a maintenance effect when maintenance of the equipment is performed for the anomaly; and an output unit that outputs, based on the maintenance effect, information identifying recommended maintenance to be performed for the anomaly in the equipment.

As a result, it is possible to support productivity improvement similarly to the above information processing method.

For example, the information processing device according to one aspect of the present disclosure may further include an obtainer that obtains operation statuses of the equipment before and after the maintenance is performed.

Therefore, since the operation statuses of the equipment before and after the maintenance is actually performed are obtained, it is possible to output information identifying recommended maintenance effective for improving productivity.

For example, the associator may calculate an improvement rate for the equipment resulting from the maintenance as the maintenance effect based on the operation statuses of the equipment before and after the maintenance is performed.

Thus, the improvement rate resulting from the maintenance is calculated, enabling the output information identifying maintenance that is directly linked to productivity improvement.

For example, the associator may associate the maintenance effect with each of a plurality of anomalies that have occurred in the equipment. The information processing device may further include a setter that sets, based on the maintenance effect, a priority on information identifying recommended maintenance for the corresponding anomaly for each of the plurality of anomalies. The output units may associate the information identifying the recommended maintenance with the priority and output the information.

Thus, the priority is associated with the recommended maintenance, enabling the determination of the work order of maintenance based on the priority. By reducing the room for human determination in setting the priority, the dependency on a human for determining the work order of maintenance can be reduced.

In the following, embodiments will be specifically described with reference to the drawings.

Note that the embodiments described below show comprehensive or specific examples. Numerical values, shapes, materials, components, the arrangement positions and connection modes of the components, steps, the order of the steps, and the like, which will be shown in the following embodiments, are only examples and are not intended to limit the present disclosure. Among the components in the following embodiments, components not recited in the independent claims are described as optional components.

Each figure is a schematic diagram and is not necessarily strictly illustrated. Therefore, for example, the scale and the like of each figure do not necessarily coincide. In each figure, substantially identical components are denoted by the same reference numerals, and redundant descriptions are omitted or simplified.

### EMBODIMENT

### 1. Overview

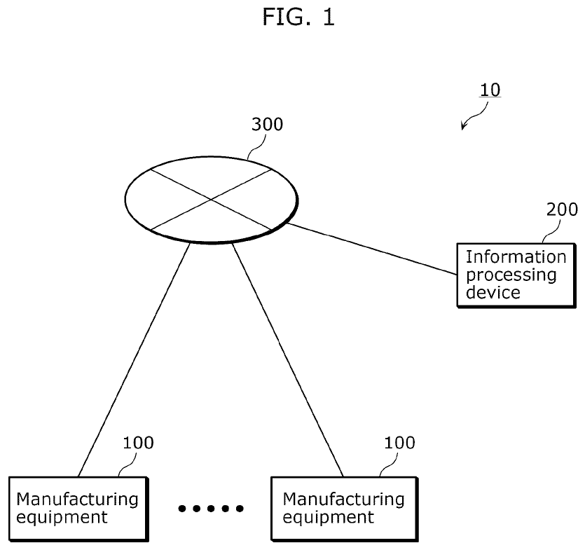

First, an overview of an information processing system according to an embodiment will be described with reference to FIG. 1. FIG. 1 is a diagram illustrating a configuration of information processing system 10 according to the present embodiment.

Information processing system 10 illustrated in FIG. 1 is a system used in a production system, such as a factory, to support equipment maintenance. Specifically, information processing system 10 outputs information identifying recommended maintenance to be performed for an anomaly in equipment based on a maintenance effect when maintenance is performed on the equipment.

As illustrated in FIG. 1, information processing system 10 includes a plurality of pieces of manufacturing equipment 100 and information processing device 200. The plurality of pieces of manufacturing equipment 100 and information processing device 200 are communicatively connected via network 300. The communication is performed by wireless communication, wired communication, or a combination of both.

Each of the plurality of pieces of manufacturing equipment 100 performs one of a plurality of steps for manufacturing a product. Manufacturing equipment 100 is, for example, a member mounting machine, a processing device, an assembly device, or the like, but is not limited thereto. Manufacturing equipment 100 produces a member by performing the step and outputs the produced member.

The member is, for example, a part included in a final product (that is, a product) or a work-in-process during the manufacturing of the final product, but is not limited thereto. The member is an object used to produce a part or work-in-process and may not be included in the final product. Note that manufacturing equipment 100 only needs to be equipment involved in the manufacture of a product and may be an inspection device that inspects a member, work-in-process, or product.

In the present specification, “production” means not only the creation of a final product but also the processing, assembly, and inspection of members (parts or work-in-process). For example, a member produced by manufacturing equipment 100 is a member that is output after manufacturing equipment 100 has performed its assigned step (processing, assembly, inspection, or the like). In addition, “manufacture” is an example of production, and “manufacturing” is used in the same sense as “production” when the final product is an industrial product.

Manufacturing equipment 100 is generally subjected to recovery work and maintenance. Maintenance is work different from recovery work. In the following, the difference between recovery work and maintenance will be described.

Recovery work is work to restart stopped equipment and is completed in a relatively short period of time. A short period of standby (temporary stoppage), referred to as a “short-time stoppage” occurs in manufacturing equipment 100. Temporary stoppages are caused by factors such as material shortage, waiting for parts from a previous step, waiting for a process in a later step, and misalignment of equipment elements. Recovery work will be performed when a temporary stoppage occurs. For example, recovery work is performed as needed each time a stoppage occurs. Recovery work includes, for example, resetting equipment, filling material, and eliminating misalignment of equipment elements.

Maintenance is work to eliminate a defective condition in equipment and takes a relatively long period of time. For example, when manufacturing equipment 100 enters a defective condition due to the occurrence of some anomaly, temporary stoppages occur frequently. In this case, even if recovery work is performed, a fundamental solution cannot be achieved unless the anomaly is resolved. In such a situation, maintenance is performed. Maintenance is performed at a predetermined timing, for example, periodically. Maintenance includes, for example, investigating and addressing the causes of defective conditions, inspecting the entire equipment, and replacing parts or tools.

Generally, in a situation where a plurality of pieces of manufacturing equipment 100 are in operation, such as in a factory, various stoppage factors (anomalies) occur simultaneously for the plurality of pieces of manufacturing equipment 100. When an anomaly occurs in manufacturing equipment 100, maintenance is performed at a specific timing to increase the operating rate of manufacturing equipment 100.

It has been found through experience that some anomalies have no maintenance effect or only a very small maintenance effect. However, the number of combinations of equipment and anomalies is enormous, making it difficult for people to determine which maintenance for which anomaly is to be preferentially performed. Because people make different determinations based on their experiences and other factors, productivity improvement may not be sufficient depending on the order in which maintenance is performed. Therefore, it is expected that a computer device will automatically determine which maintenance for which anomaly is to be preferentially performed.

Information processing device 200 according to the present embodiment outputs information identifying recommended maintenance to be performed for an anomaly in manufacturing equipment 100 based on a maintenance effect when maintenance is performed for the anomaly in manufacturing equipment 100. The maintenance effect can be used to effectively support the productivity improvement of manufacturing equipment 100.

Information processing device 200 is one or more computer devices including a processor and memory. The processor reads and executes a program stored in the memory to perform a predetermined process. Note that at least some of the processes performed by information processing device 200 may be performed by a dedicated circuit.

### 2. Information Processing Device

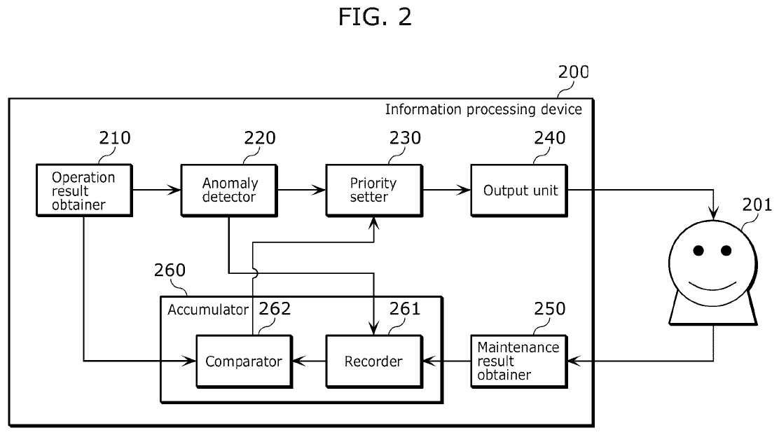

Subsequently, the specific configuration of information processing device 200 will be described with reference to FIG. 2. FIG. 2 is a block diagram illustrating the configuration of information processing device 200 according to the present embodiment.

As illustrated in FIG. 2, information processing device 200 includes operation result obtainer 210, anomaly detector 220, priority setter 230, output unit 240, maintenance result obtainer 250, and accumulator 260.

Operation result obtainer 210 obtains operation result data indicating the operation status of each manufacturing equipment 100. For example, the operation status includes the equipment identification (ID), stoppage time, stoppage factor, and operating time of manufacturing equipment 100. Each manufacturing equipment 100 is equipped with one or more sensors to detect the operation status of manufacturing equipment 100. The operation result data includes, for example, time-series data of sensor values output from a sensor (sensor data). The obtained operation result data is recorded in accumulator 260.

Operation result obtainer 210 obtains the operation statuses of manufacturing equipment 100 before and after operator 201 performs maintenance. For example, operation result obtainer 210 obtains the operation status of manufacturing equipment 100 periodically (for example, every second). The obtained operation status is associated with the time when the status is obtained. This enables operation result obtainer 210 to obtain the operation statuses before and after the maintenance.

Anomaly detector 220 calculates the anomaly level of the anomaly that has occurred in manufacturing equipment 100 based on the operation result data obtained by operation result obtainer 210. In the present embodiment, the anomaly level becomes a higher value as the degree of the anomaly in manufacturing equipment 100 becomes greater. When the calculated anomaly level is higher than a threshold, anomaly detector 220 detects that an anomaly has occurred in corresponding manufacturing equipment 100.

The anomaly level is calculated, for example, based on an operating time distribution estimated for each manufacturing equipment 100. The operating time distribution can be represented in terms of an operating time distribution, which is a simultaneous distribution of operating time and stoppage factors. The operating time distribution is estimated by constructing a predetermined estimation model through machine learning using the operation result data for a predetermined amount of time as input data. The estimation model is, for example, a regression model using Bayesian estimation, but is not limited thereto. The machine learning method is not particularly limited. For example, a method using a classifier, a method using a support vector machine, a decision tree method, a deep convolutional neural network method, and the like can be used as supervised learning methods.

Note that the method for calculating the anomaly level is not limited as long as the degree of anomaly in manufacturing equipment 100 can be expressed. For example, the anomaly level may be a value obtained by statistically processing the operation result data. As an example, the anomaly level may be calculated as the stoppage frequency of manufacturing equipment 100, the cumulative value of stoppage times, or the like.

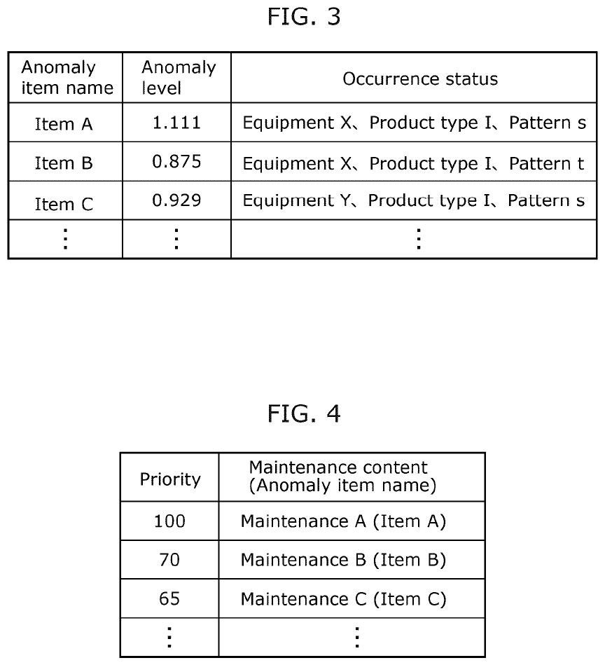

Anomaly detector 220 outputs detected anomaly data to priority setter 230 and accumulator 260. The detected anomaly data is data related to the detected anomaly. FIG. 3 is a diagram illustrating an example of the detected anomaly data. As illustrated in FIG. 3, the detected anomaly data includes the anomaly item name (stoppage factor), the calculated anomaly level, and the occurrence status of the anomaly. The occurrence status includes the equipment ID of manufacturing equipment 100 where the anomaly has occurred, the product type ID of the product being manufactured by equipment 100, and the type of sensor data pattern. The pattern of sensor data is the graphical shape of the sensor data for a predetermined period before the occurrence of the anomaly. The type of the pattern is defined, for example, by a combination of the absolute value of the sensor value, the frequency and magnitude of the fluctuation, and the like.

Priority setter 230 sets a priority on information identifying recommended maintenance for the corresponding anomaly for each of a plurality of anomalies, based on a maintenance effect calculated by accumulator 260. In the present embodiment, the recommended maintenance to be performed for the anomaly is predetermined, and the anomaly and the recommended maintenance correspond one-to-one.

Priority setter 230 sets the priority based on the maintenance effect and the anomaly level. The maintenance effect is, for example, the improvement rate for the operation status of manufacturing equipment 100 resulting from maintenance. The method for calculating the improvement rate will be described later. Priority setter 230 sets the product of the anomaly level and the improvement rate as the priority level. That is, the priority is expressed by the following Equation (1).

$$Priority = Anomaly Level \times Improvement Rate \qquad ( 1 )$$

Output unit 240 outputs, based on the maintenance effect, information identifying recommended maintenance to be performed for the anomaly in manufacturing equipment 100 (maintenance information). The maintenance information is information that can notify operator 201 of the recommended maintenance work content. In the present embodiment, since the anomaly (anomaly item name) and the recommended maintenance correspond one-to-one, the maintenance information may be the item name of the anomaly that has occurred in manufacturing equipment 100.

In the present embodiment, output unit 240 associates the maintenance information with the priority level and outputs the maintenance information. FIG. 4 is a diagram illustrating an example of the maintenance information that is output.

As illustrated in FIG. 4, each recommended maintenance work content is associated with the priority level set by priority setter 230. In the example illustrated in FIG. 4, pieces of maintenance information are arranged in descending order of priority.

The maintenance information is output and displayed, for example, on a portable terminal owned by operator 201 or on a display device browsable by operator 201. Operator 201 can determine the recommended maintenance to be performed by reviewing the maintenance information. For example, operator 201 can determine that the recommended maintenance with the highest priority (in the example of FIG. 4, maintenance A for anomaly item A) is to be performed.

Maintenance result obtainer 250 obtains information related to the maintenance performed by operator 201 (maintenance result information). The maintenance result information includes, for example, the work content of the maintenance performed by operator 201 and the performance time of the maintenance. The performance time is at least one of the start time or the end time of the maintenance.

The maintenance result information is input via the portable terminal (not illustrated) owned by operator 201. Maintenance result obtainer 250 obtains the input maintenance result information by communicating with the portable terminal. Alternatively, maintenance result obtainer 250 may obtain the maintenance result information from manufacturing equipment 100. For example, manufacturing equipment 100 may be equipped with an input unit for inputting the start or end of maintenance, and the maintenance performance time may be input via the input unit. Alternatively, the maintenance performance time may be the operating time (production start time) of manufacturing equipment 100 after maintenance.

Accumulator 260 is an example of an associator, and associates information related to an anomaly that has occurred in manufacturing equipment 100 with the maintenance effect when the maintenance of manufacturing equipment 100 is performed for the anomaly. Specifically, accumulator 260 associates the maintenance result information, the operation status of manufacturing equipment 100, and the anomaly detection result, and stores these in a storage (not illustrated). Accumulator 260 also calculates the maintenance effect and stores the calculated maintenance effect in the storage (not illustrated). Note that the storage (not illustrated) is a non-volatile storage device, such as a magnetic disk like a hard disk drive (HDD) or a semiconductor memory like a solid-state drive (SSD). The storage may be a storage device included in information processing device 200, or may be a storage device included in a server device or the like with which information processing device 200 can communicate.

As illustrated in FIG. 2, accumulator 260 includes recorder 261 and comparator 262.

Recorder 261 records maintenance result data in which information (for example, an anomaly item name) identifying an anomaly that has motivated maintenance, the occurrence time of the anomaly, and the maintenance performance time are associated. Each time maintenance is performed, recorder 261 generates and records the maintenance result data, based on the detected anomaly data output from anomaly detector 220 and the maintenance result information obtained by maintenance result obtainer 250.

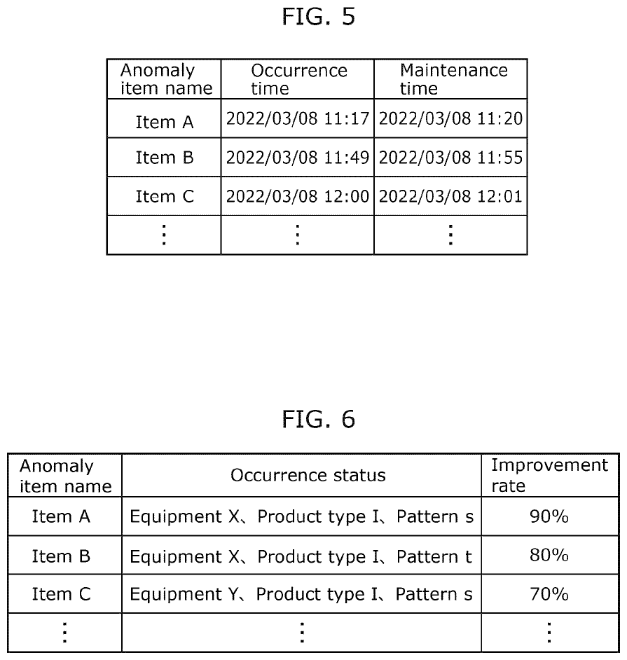

FIG. 5 is a diagram illustrating an example of the maintenance result data recorded by recorder 261. As illustrated in FIG. 5, each anomaly item name is associated with the anomaly occurrence time and the maintenance performance time. Note that the maintenance work content may be associated instead of the anomaly item name.

Comparator 262 calculates the improvement rate for manufacturing equipment 100 resulting from maintenance as a maintenance effect, based on the operation statuses of manufacturing equipment 100 before and after the maintenance is performed. Specifically, comparator 262 compares the operation status of manufacturing equipment 100 before the maintenance is performed with the operation status of manufacturing equipment 100 after the maintenance is performed. The operation status is, for example, the cumulative value of stoppage times of manufacturing equipment 100 due to an anomaly that has motivated maintenance. The improvement rate is expressed by the following Equation (2).

$$Improvement Rate = ( Cumulative Stoppage Time Before Maintenance - Cumulative Stoppage Time After Maintenance ) \div Cumulative Stoppage Time Before Maintenance \qquad ( 2 )$$

The cumulative stoppage time before the maintenance is a first cumulative value of stoppage times due to the anomaly during a first period before the maintenance is performed. The cumulative stoppage time after maintenance is a second cumulative value of stoppage times due to the anomaly during a second period after the maintenance is performed. Comparator 262 calculates the first cumulative value and the second cumulative value, and calculates the improvement rate based on Equation (2).

Note that the first period is a predetermined period immediately before the time when the maintenance is performed. The predetermined period is, for example, three days, but is not particularly limited. The second period is a period of the same length as the first period. The second period is a predetermined period immediately after the time when maintenance is performed.

Accumulator 260 stores the improvement rate calculated by comparator 262 in association with the anomaly item name and the occurrence status. FIG. 6 is a diagram illustrating an example of maintenance effect data. As illustrated in FIG. 6, the anomaly item name, occurrence status, and improvement rate are associated.

### 3. Operation

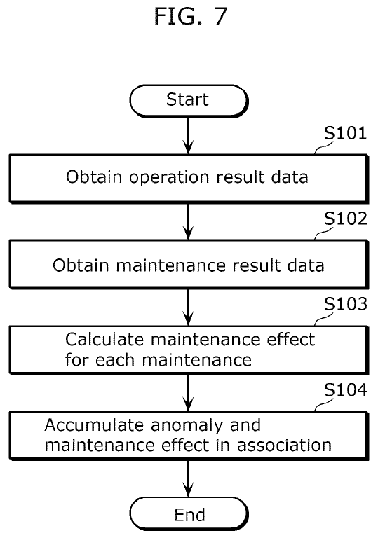

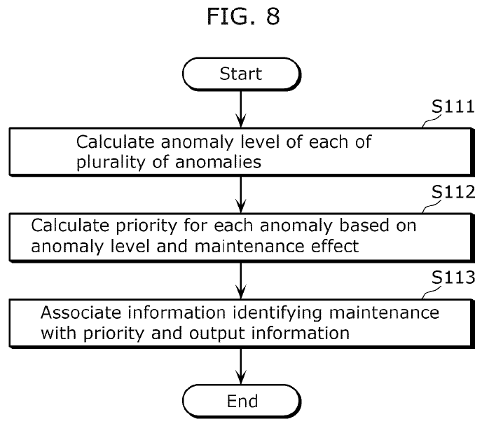

Subsequently, the operation of information processing system 10 according to the present embodiment will be described with reference to FIGS. 7 and 8.

FIG. 7 is a flowchart illustrating an accumulation process for maintenance effect data in the operation of information processing device 200 according to the present embodiment. As illustrated in FIG. 7, first, operation result obtainer 210 obtains operation result data (S101). Then, maintenance result obtainer 250 obtains maintenance result data (S102).

Next, accumulator 260 calculates a maintenance effect for each maintenance performed (S103). Specifically, comparator 262 calculates an improvement rate as the maintenance effect, using cumulative values of stoppage times before and after maintenance, based on Equation (2). Then, accumulator 260 records the calculated improvement rate (maintenance effect) in association with the anomaly (S104). Thereby, the maintenance effect data illustrated in FIG. 6 is recorded. Each time maintenance is performed, the maintenance effect is calculated and recorded for each maintenance performed (each anomaly that has motivated the maintenance). As the number of times maintenance is performed increases, the number of calculated maintenance effects increases, and the calculation accuracy of the maintenance effect improves. As the operating time of the production system increases, maintenance effects resulting from maintenance performed for actual anomalies are calculated and accumulated with greater accuracy. As a result, the effectiveness of priorities set based on the maintenance effects also increases, enabling effective support for productivity improvement.

In FIG. 7, the maintenance effect calculation (S103) and accumulation (S104) are performed each time maintenance is performed, that is, each time maintenance result data is obtained. Alternatively, the maintenance effect calculation (S103) and accumulation (S104) may be performed periodically (for example, every day) for all maintenance performed during the period.

FIG. 8 is a flowchart illustrating an output process for maintenance information in the operation of information processing device 200 according to the present embodiment. As illustrated in FIG. 8, anomaly detector 220 calculates the anomaly level of each of a plurality of anomalies (S111). Next, priority setter 230 calculates a priority for each anomaly based on the anomaly level and the maintenance effect (S112). The priority is calculated based on, for example, Equation (1). Next, output unit 240 associates information identifying recommended maintenance with the priority and outputs the information. (S113). For example, the maintenance information illustrated in FIG. 4 is output. Thus, since the priority is associated with each anomaly item name (recommended maintenance), operator 201 can easily understand the order in which maintenance is to be performed for anomalies that have occurred. By performing maintenance based on the output priorities without relying on the determination of operator 201, productivity can be improved efficiently.

When maintenance has not been performed in the past and the maintenance effect has not been calculated, no priority is set. In this case, apart from maintenance information with priorities set, output unit 240 outputs maintenance information to indicate that there is no result (that is, it is the first anomaly that has occurred and maintenance has not been performed in the past). This makes it possible to prevent a low priority from being set on maintenance information with no maintenance result and to encourage the performance of maintenance that has not been previously performed. Performing maintenance that has not been previously performed enables the priority to be set based on its maintenance effect when the same anomaly occurs next.

The process illustrated in FIG. 8 is performed, for example, on a regular basis (for example, every day) for all anomalies that have occurred during the period. Alternatively, the process illustrated in FIG. 8 may be performed each time an anomaly occurs, and the priority set on each anomaly may be updated as needed.

### OTHER EMBODIMENTS

Although the information processing method and the information processing device according to one or more aspects have been described above based on the embodiment, the present disclosure is not limited to the embodiment. Without departing from the gist of the present disclosure, various modifications conceived by a person skilled in the art to the present embodiment and forms constructed by combining components of different embodiments are also included within the scope of the present disclosure.

For example, in the above embodiment, an example has been shown where the priority is expressed by the product of the anomaly level and the improvement rate, but the priority may be the improvement rate itself. That is, the anomaly level may not be used in the calculation of the priority.

For example, in the above embodiment, an example of using the stoppage time in the calculation of the improvement rate has been shown, but the present disclosure is not limited thereto. For example, the number of stoppages (stoppage frequency) may be used in the calculation of the improvement rate. For example, the improvement rate may be expressed by the following Equation (3).

$$Improvement Rate = ( Number of Stoppages Before Maintenance - Number of Stoppages After Maintenance ) \div Number of Stoppages Before Maintenance \qquad ( 3 )$$

The number of stoppages before maintenance is the number of stoppages due to an anomaly during a first period after maintenance is performed. The number of stoppages after maintenance is the number of stoppages due to the anomaly during a second period after the maintenance is performed. Comparator 262 may calculate the number of stoppages before and after the maintenance, and calculate the improvement rate based on Equation (3). Note that the first period and the second period are the same as those of the above embodiment.

For example, the anomaly and the maintenance work content do not need to correspond one-to-one. For example, there may be a plurality of candidates for recommended maintenance to be performed for one anomaly. In this case, in the maintenance result data illustrated in FIG. 5 and the maintenance effect data illustrated in FIG. 6, information identifying the performed maintenance (for example, the work name or work content of the maintenance) is recorded, instead of or in addition to the anomaly item name.

For example, in the above embodiment, an example has been shown where information processing device 200 supports maintenance for the plurality of pieces of manufacturing equipment 100, but information processing device 200 may support maintenance for only one piece of manufacturing equipment 100.

For example, an example has been shown where pieces of maintenance information are sorted and displayed based on priorities, but the display mode is not particularly limited. The maintenance information may be output by voice or other means, instead of or in addition to being displayed.

The communication method between devices described in the above embodiment is not particularly limited. When wireless communication is performed between devices, the wireless communication method (communication standard) is, for example, near-field wireless communication such as ZigBee (registered trademark), Bluetooth (registered trademark), or wireless LAN (Local Area Network). Alternatively, the wireless communication method (communication standard) may be communication via a wide-area communication network such as the Internet. Wired communication may be performed between devices instead of wireless communication. Specifically, wired communication is power line communication (PLC), communication using a wired LAN, or the like.

In the above embodiment, a process performed by a specific processing unit may be performed by another processing unit. The order of a plurality of processes may be changed, or a plurality of processes may be performed in parallel. The allocation of components included in a work notification system to a plurality of devices is one example. For example, a component included in one device may be included in another device.

For example, the processes described in the above embodiment may be implemented by centralized processing using a single device (system) or by distributed processing using a plurality of devices. The number of processors that execute the above program may be single or multiple. That is, the centralized processing or distributed processing may be performed.

In the above embodiment, all or part of the components, such as a controller, may be formed of dedicated hardware or may be implemented by executing a software program suitable for each component. Each component may be implemented by a program executor, such as a central processing unit (CPU) or a processor, reading and executing a software program recorded on a recording medium, such as an HDD or semiconductor memory.

The components such as the controller may include one or more electronic circuits. The one or more electronic circuits may each be a general-purpose circuit or a dedicated circuit.

The one or more electronic circuits may include, for example, a semiconductor device, an integrated circuit (IC), or a large-scale integrated circuit (LSI). The ICs or LSIs may be integrated into one chip or a plurality of chips. Here, the electronic circuits are referred to as ICs or LSIs but may be referred to as system LSIs, very-large-scale integrated circuits (VLSIs), or ultra-large-scale integrated circuits (ULSIs) depending on the degree of integration. A field-programmable gate array (FPGA), which is programmed after the manufacture of the LSI, can also be used for the same purpose.

The general or specific aspect of the present disclosure may be implemented by a system, device, method, integrated circuit, or computer program. Alternatively, the general or specific aspect of the present disclosure may be implemented by a non-temporary computer-readable recording medium, such as an optical disk, HDD, or semiconductor memory, in which the computer program is stored. The general or specific aspect of the present disclosure may be implemented by any combination of the system, apparatus, method, integrated circuit, computer program, and recording medium.

Various modifications, replacements, additions, omissions, and the like can be made to each of the above embodiments within the scope of the claims or their equivalents.

### INDUSTRIAL APPLICABILITY

The present disclosure can be used as an information processing method and the like capable of supporting productivity improvement, and can be used, for example, in a factory management system, production system, and the like.

### REFERENCE SIGNS LIST

10 information processing system
100 manufacturing equipment
200 information processing device
201 operator
210 operation result obtainer
220 anomaly detector
230 priority setter
240 output unit
250 maintenance result obtainer
260 accumulator
261 recorder
262 comparator
300 network

1. An information processing method comprising:
associating information related to an anomaly that has occurred in equipment with a maintenance effect when maintenance of the equipment is performed for the anomaly; and
outputting, based on the maintenance effect, information identifying recommended maintenance to be performed for the anomaly in the equipment.

2. The information processing method according to claim 1, further comprising:
obtaining operation statuses of the equipment before and after the maintenance is performed.

3. The information processing method according to claim 2,
wherein in the associating, an improvement rate for the equipment resulting from the maintenance is calculated as the maintenance effect based on the operation statuses of the equipment before and after the maintenance is performed.

4. The information processing method according to claim 3,
wherein in the associating, a first cumulative value of stoppage times due to the anomaly during a first period before the maintenance is performed and a second cumulative value of stoppage times due to the anomaly during a second period of a same length as the first period after the maintenance is performed are calculated, and a ratio of a difference value, obtained by subtracting the second cumulative value from the first cumulative value, to the first cumulative value is calculated as the improvement rate.

5. The information processing method according to claim 1,
wherein in the associating, the maintenance effect is associated with each of a plurality of anomalies that have occurred in the equipment,
the information processing method further comprises setting, based on the maintenance effect, a priority on information identifying recommended maintenance for a corresponding anomaly for each of the plurality of anomalies, and
in the outputting, the information identifying the recommended maintenance is associated with the priority and is output.

6. The information processing method according to claim 5, further comprising:
calculating an anomaly level of each of the plurality of anomalies that has occurred in the equipment,
wherein in the setting, the priority is set based on the maintenance effect and the anomaly level.

7. The information processing method according to claim 6,
wherein in the setting, a product of the maintenance effect and the anomaly level is set as the priority.

8. A non-transitory computer-readable recording medium having recorded thereon a program for causing a computer to execute the information processing method according to claim 1.

9. An information processing device comprising:
an associator that associates information related to an anomaly that has occurred in equipment with a maintenance effect when maintenance of the equipment is performed for the anomaly; and
an output unit that outputs, based on the maintenance effect, information identifying recommended maintenance to be performed for the anomaly in the equipment.

10. The information processing device according to claim 9, further comprising:
an obtainer that obtains operation statuses of the equipment before and after the maintenance is performed.

11. The information processing device according to claim 10,
wherein the associator calculates an improvement rate for the equipment resulting from the maintenance as the maintenance effect based on the operation statuses of the equipment before and after the maintenance is performed.

12. The information processing device according to claim 9,
wherein the associator associates the maintenance effect with each of a plurality of anomalies that have occurred in the equipment,
the information processing device further comprises a setter that sets, based on the maintenance effect, a priority on information identifying recommended maintenance for a corresponding anomaly for each of the plurality of anomalies, and
the output unit associates the information identifying the recommended maintenance with the priority and outputs the information.
